(19) United States
(12) Patent Application Publication
(10) Pub. No.: US 2003/0050098 A1
(43) Pub. Date: Mar. 13, 2003

(54) Apparatus, system and method for an improved mobile station and base station

(76) Inventors: Laurence D'Agati, Melbourne, FL (US); Gary Matthews, Satellite Beach, FL (US); Donald Chaffee, Satellite Beach, FL (US)

Correspondence Address: Thomas A. O'Rourke, Wyatt, Gerber & O'Rourke, 99 Park Avenue, New York, NY, 10016, US

(21) Appl. No.: 09/950,040

(22) Filed: Sep. 10, 2001

(51) Int. Cl. H04M 1/00

(52) U.S. Cl. 455/561; 455/550

(57) ABSTRACT

A wireless communication system, method and apparatus are disclosed. This system includes one or more apparatus for communicating with one or more base stations and one or more mobile. The apparatus has both a base station portion and a mobile station portion. The base station portion is adapted to communicate with one or more mobile stations and/or with one or more other mobile station portions while the mobile station portion is adapted to communicate with one or more other base stations and or one or more other base station portions.

### FIELD OF THE INVENTION

The present invention relates to improved wireless communication devices and in particular an apparatus that combines the functionality and attributes of a mobile station and a base station in a single integrated device. The present invention also relates to a communication system having one or more of these apparatus and methods of communicating using these devices.

### BACKGROUND OF THE INVENTION

Wireless communications are a growing field and there has been a significant proliferation of, for example, mobile telephones and other mobile devices in recent years. Conventional mobile radio communication systems typically include a plurality of base stations and a plurality of mobile stations. The mobile stations can communicate with the plurality of base stations individually by radio. Each of the base stations has a coverage region (cell) in which it provides services, and in principle, the mobile station communicates with one of the base stations, which has a wireless zone in which the mobile station is currently present. A wireless zone has a plurality of cells. Mobile stations can be connected to one of the base stations via radio link. A call which is connected between a base station and a mobile station moving toward another base station adjacent to the earlier-mentioned base station must be handed over to the other base station, toward which the mobile station is moving. The call hand-off is dealt with call hand-off sequences between the two base stations under the control of a base station control office. The call hand-off is one of the characteristic features of the cellular mobile telecommunications system, regardless of the radio link scheme, such as analog or digital transmission system, or FDMA (frequency-division multiple access), TDMA (time-division multiple access) or CDMA (code-division multiple access) system.

While cellular telephones and other wireless communication devices are popular with consumers, the attendant base stations usually are not. Base stations, due to their size and the presence of radio waves are frequently politically difficult to locate in many locales. Adjacent property owners may object to the proximity of the base stations. In addition, many property owners who are not adjacent the base station object on the ground of aesthetics. As a result, the need for additional base stations to increase the wireless coverage in a given area as well as the quality of that coverage is sometimes difficult to accomplish.

Another major concern to the operating companies of a wireless cellular network is the provision of adequate capacity to subscribers so that their service expectations are met. Services are provided to subscribers wirelessly from fixed infrastructure. Each base station has a certain limited capacity to serve subscribers over a limited geographical area. Capacity is limited by the number of radio channels allotted to the base station. Coverage area is limited by the effective communication range of these base stations in combination with the effective range of the subscriber's mobile station.

As a result, there is a need for a new type of apparatus that can supplement the traditional base station and provide additional capacity and coverage without the need for large and costly base stations and the political problems that can arise from their construction.

### OBJECTS OF THE INVENTION

It is an object of the present invention to provide communications system that provides improved communications by the use of an apparatus that incorporates the functions of a base station and a mobile station.

It is an object of the present invention to provide an apparatus that reduces the need for additional traditional base stations

It is an object of the present invention to provide a method of transmitting communication signals including radio waves to a device that operates as a base station as well as a mobile station.

It is an object of the invention to provide an improved base station that may be multi-functional in that it has the attributes of both a base station and a mobile station.

It is an object of the present invention to provide an improved mobile station that is multi-functional in that it has the attributes of both a mobile station and a base station.

It is a further object of the invention to distribute available network capacity to match changing user densities.

It is still another object of the invention to provide network compatibility without necessitating a BTS modification and/or MS modification.

It is a still further object of the invention to provide simple integration into existing network infrastructure.

### SUMMARY OF THE INVENTION

The present invention is directed to an apparatus that combines the functionality and attributes of a mobile station and a base station in a single integrated device. The apparatus of the present invention is a self-contained or autonomous unit that may simultaneously function as both a mobile station transceiver and a base station transceiver. The configuration of the device is such that the physical resources within the device may be shared by any one or more mobile stations, base stations and other devices of the same type as the present invention. Processing within the device allows for communication between the MS portion and the BTS portion. The communication between the MS portion and the BTS portion permits sharing of resources so that critical performance parameters may be managed to minimize latency through the device. The present invention also minimizes link degradation on received channels.

The apparatus of the present invention also enables adaptive cellular load distribution within networks by being able to route signals to multiple base stations. The device permits the distribution of available network capacity to dynamically match changing user densities. This is accomplished with relatively simple integration into existing network infrastructure.

### BRIEF DESCRIPTION OF THE DRAWINGS

FIG. 1 depicts a block diagram of the apparatus of the present invention showing both the mobile station transceiver and base station transceiver parts as well as the control processor, which controls and manages the operation thereof.

FIG. 2 shows a representative circuit between the MS function and BTS function within the apparatus of FIG. 1 in order to enable efficient communications.

FIG. 3 shows a transceiver in accordance with the present invention which comprises multiple physical channels.

FIG. 4 depicts an example of the protocol stacks, interworking functions, and management processes that control communications within the device in order to transfer data between BTS to nMS links and MS to nBTS links.

FIG. 5 is a block diagram of a representative channel process.

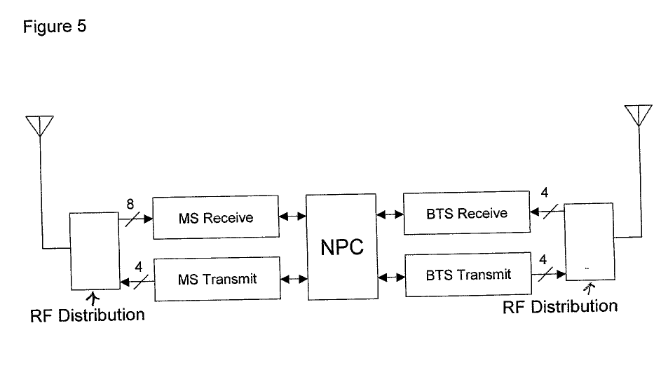

FIG. 6 shows an example of the network topology of the present invention where multiple devices are operating.

FIG. 7 depicts the processing of a channel within the device to minimize latency while maintaining good link performance.

FIG. 8 shows a representative network configuration.

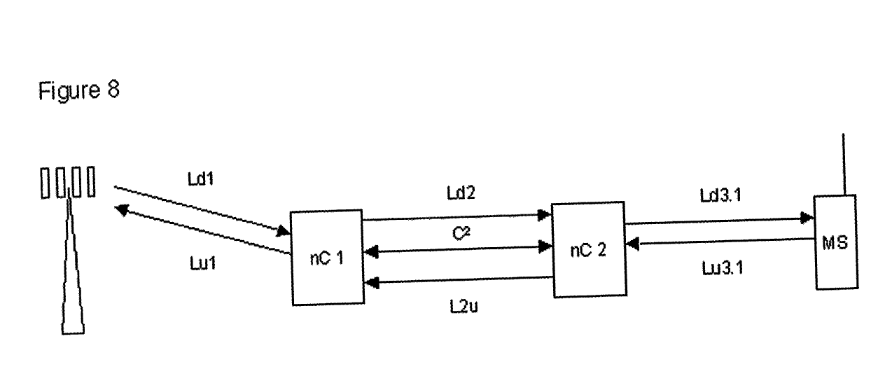

### DETAILED DESCRIPTION OF THE INVENTION

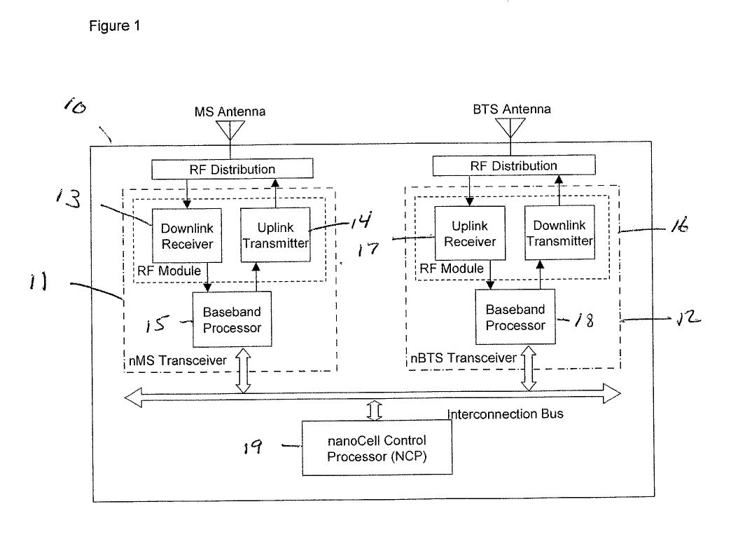

As seen in FIG. 1 the apparatus 10 of the present invention includes a MS transceiver portion 11 and a BTS transceiver portion 12. The MS transceiver portion 11 may have a downlink receiver 13 and an uplink transmitter 14 as well as a baseband processor 15. The BTS transceiver portion 12 similarly may be provided with a downlink transmitter 16, a uplink receiver 17 and a baseband processor 18. In other embodiments, the BTS portion may have both a down link receiver as well as a downlink transmitter or an uplink receiver and an uplink transmitter. The MS portion in such instance may have respectively, an uplink receiver and an uplink transmitter or the down link receiver and a downlink transmitter. Control of the MS functionality and the BTS functionality is provided by the control processor (NCP) 19. Preferably each apparatus of the present invention will have at least one control processor. However, it may be possible for one control processor to control the operation of more than one device. As used herein the term mobile station (MS) can include the traditional mobile station used in wireless telecommunication as well as user stations, terminals and subscriber units as these terms are generally known and used in the art.

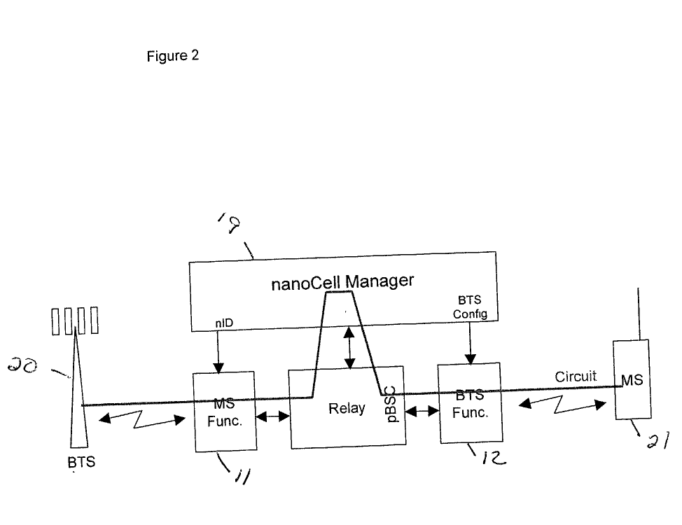

The function of the control processor 19 in the present invention is to provide a connection between the MS side and the BTS side of the device in order to enable efficient transfer of information through the apparatus, as shown in FIG. 2. FIG. 2 shows a base station 20 that is in communication with the mobile transceiver portion 11 of the device. In this example, a radio message, sent by the BTS 20, is received by the mobile transceiver portion 11 of the device. The message is relayed using the control processor 19 to the BTS transceiver portion 12 of the device where it is further transmitted to another mobile station 21 or to another device of the present invention. The base station 20 can be a traditional base station, a satellite or may be the base station portion of another device of the present invention. The mobile station may also be a conventional mobile station or may be the mobile station portion of another apparatus of the present invention.

It is important to note that the radio links on either side of the device, that is the BTS to nMS air interface and the MS to nBTS air interface, are preferably decoupled so that frequency management, timing, power management, error correction, etc., are constrained to the physical layer of individual links. This feature enables a preponderance of devices of the present invention to interconnect among themselves in a polymorphic network architecture without constraints caused by the number of hops or channel impairments in a portion of the network. A polymorphic cellular network is described in copending U.S. patent application Ser. No. 09/739,351 filed Dec. 18, 2000, entitled “A Polymorphic Cellular Architecture, the disclosures of which are incorporated herein by reference.

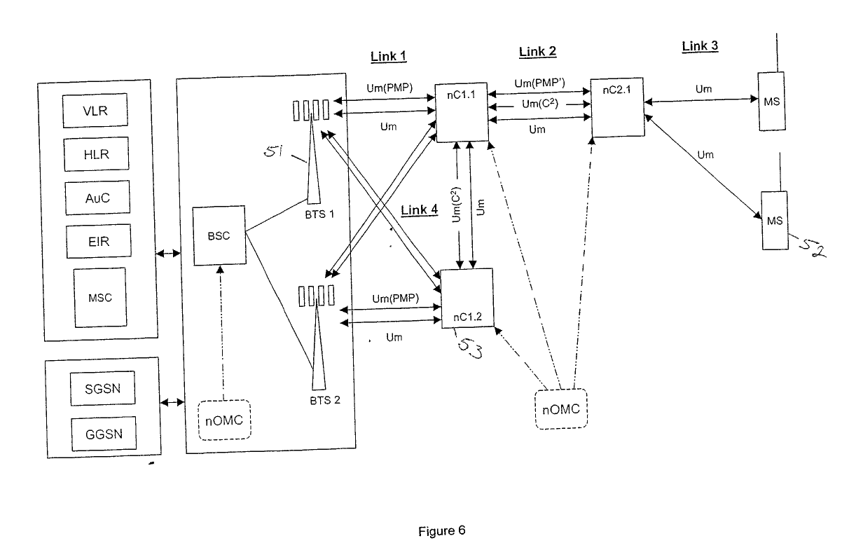

FIG. 6 depicts an example of some of the various communications options of the device of the present invention in communicating with other base stations 51, other mobile devices 52 and other devices of the present invention 53. The path for the communication of mobile devices can be determined in accordance with the teachings of copending U.S. patent application Ser. No. 09/808,635 filed Mar. 14, 2001, entitled Efficient Path Learning in a Network, the disclosures of which are incorporated herein by reference. Although the present invention has particular application in wireless communication systems it also can be used in wired and fiber optic communication systems.

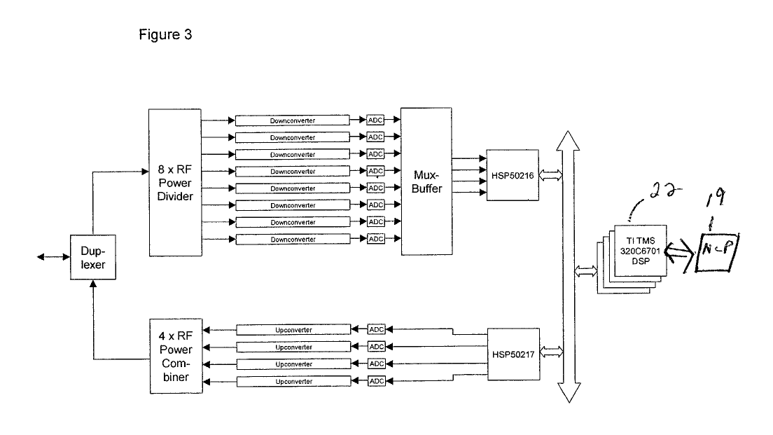

As shown in FIG. 3 a device will preferably contain multiple physical channels for both the MS side and BTS side communications. It is preferred but not required that more MS receive channels be present than transmit channels so that the device may more readily track additional BTS beacon channels or other similar devices. The number of physical channels can vary depending on the needs of the network or other considerations.

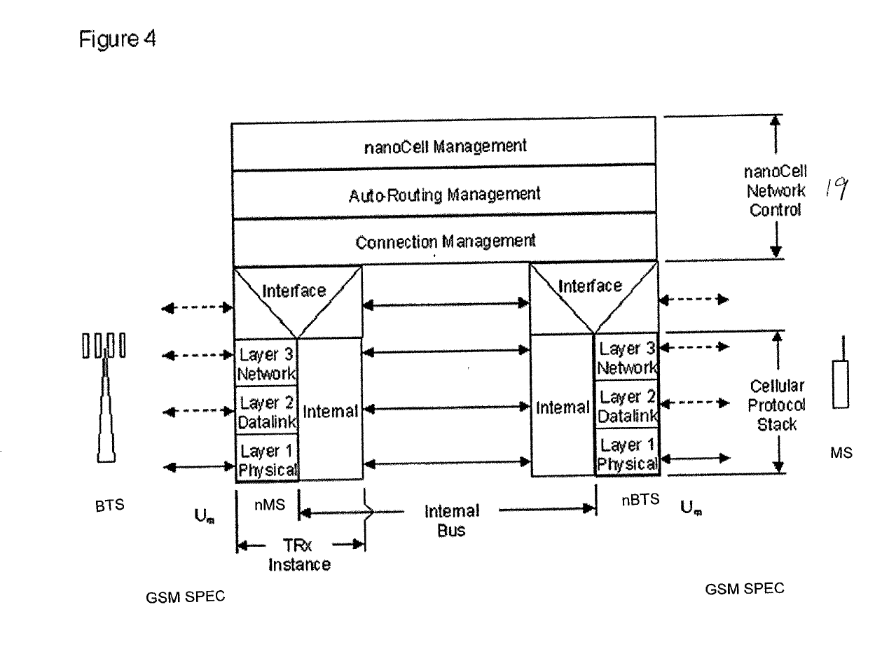

FIG. 4 shows an example of peer processes interacting within the device. As seen in FIG. 4 there are three types of management function. These are device management, auto-routing management and connection management. These management functions are usually directed from the control processor 19. The MS portion of the device that communicates with a BTS, may be provided with three layers. These are Layer 1-Physical, Layer 2-Datalink and Layer-3 Network. Similarly, the BTS portion of the device has three corresponding layers. These are also termed Layer 1-Physical, Layer 2-Datalink and Layer-3 Network.

Virtual Mobile Station and Base Station Creation by the Present Invention

In typical operation of the present invention, the apparatus creates a virtual mobile station and a virtual base station. A device will create a Mobile Station (nMS) instance within its operational program with a protocol entity that behaves as a mobile station. This virtual nMS is used to provide connectivity between a Base Transceiver Station (BTS) and the device or between another device's nBTS function and the device of the present invention. In the preferred embodiment, the nMS identity is unique to each device. A proxy MS (pMS) may be created in a similar manner in that it is virtually created within the operational program with a protocol entity that behaves as a mobile station. The difference, however, is that it takes on the identity of a mobile station (or nMS or other pMS) that is not contained within the device.

Mapping of virtual mobile stations or virtual base transceiver stations to physical hardware is managed within the Control Processor (NCP) 19. Protocol elements for each virtual instance are contained within various processing elements in the chain, which include the NCP 19 and the Digital Signal Processors (DSP) 22. Virtual mobile stations (whether nMS or pMS) will use available transceiver resources within the device to transmit and receive physical layer (layer 1) information over the air interface. The nMS is used to scan the RF spectrum for available BTS beacon frequencies with which it may connect. In this way, it behaves as a real MS behaves during a cell selection or cell reselection process. Virtual Base Transceiver Stations are created when a proxy base station (pBTS) is needed to establish a cell in the location of the device. The pBTS receives configuration information from the device manager, which determines the operating characteristics of the pBTS. Some functions that are normally contained within a Base Station Controller (BSC) are contained within the device management function providing control information for the pBTS. Virtual MSs and BTSs may be deleted when they are no longer in use by eliminating their presence in the operational program. A pBTS may broadcast information on a control channel, on a cell broadcast channel, or on a number of other channels that may be used by other devices of the present invention within the area. This information is used by these other devices to determine connectivity and routing information within the network.

Connection Management by the Apparatus of the Present Invention

The apparatus of the present invention can translate a connection from one channel to another. In this respect it operates as a repeater or a relay. However, there are significant differences between the device of the present invention and a repeater or a relay. For example, the apparatus of the present invention acts as a base station and a mobile station. A repeater or relay does not. The apparatus of the present invention is an autonomous base station and at the same time an autonomous mobile station. A repeater can communicate with a single base station and with mobile stations while the apparatus of the present invention does not have to communicate with base stations or mobile stations. The apparatus of the present invention can also communicate with devices of the same type as itself. It can communicate solely with base stations or solely with mobile stations in the loop or circuit. It has the capacity to communicate in this fashion simultaneously. A repeater or relay does not have this capability. The MB and BTS portions of present device are also decoupled whereas repeaters and relays are coupled. The decoupled aspect of the device of the present invention applies to such factors as frequency, modulation, time, amplitude, data rate and protocol. Repeaters and relays are coupled for each of these parameters.

The apparatus of the present invention also performs channel estimation from a demodulation point of view. In repeaters and relays, channel impairment can be compounded. This does not occur in the device of the present invention. Another distinguishing feature of the apparatus of the present invention is its ability to process messages that are embedded in a control channel. The device also demodulates and remodulates thereby reducing noise over the entire path. Further it makes capacity adaptive to geographic needs. One mode of operation of a repeater is when a channel from a base station (F1) is received then translated to another channel (F2) at an intermediary point, then translated back to the original frequency (F1) for transmission to a MS. This is done so that “in-band” signaling carried within F1 is consistent with the frequency plan used by the MS (eg, if a BTS commands a channel change to F5 but the repeater translates the resulting channel to F6, the mobile will not receive the correct channel without a translation back to F5). The device of the present invention would intercept the signaling information and translate that message into the correct context for the MS. In this way, channels within a coverage area are preserved (F5 and F6 may both be used for communications).

Within the typical network the use of the apparatus of the present invention creates a polymorphic network. When multiple devices of the present invention are operating (See FIG. 6), connectivity among them is determined through a connection management process. Each device contains multiple instances of mobile stations (nMS) and base stations (nBTS) that are used to provide connectivity among all relevant nodes. One characteristic of the apparatus of the present invention is that when a MS is connected to the network via the device, the device will create a virtual instance of that MS, which has been termed a “proxy Mobile Station” or pMS. The pMS will effectively acquire the characteristics of the MS for purposes of communicating with the network. The network base station that is talking to the apparatus of the present invention will believe that it is communicating directly with the MS.

The features of the present invention enable it to be used in locations where a traditional base station would be unsatisfactory or unacceptable. The device may have a relatively small size compared to the traditional base station. As a result, it may be advantageous to include a GPS system in the apparatus to facilitate monitoring any change in the device's location. The presence of the MS portion also permits the device to be controlled remotely and this feature can be used as a monitoring and maintenance tool. For this reason, in certain circumstances, the base station portion may be used to temporarily restrict the access of other MS to the network.

In order to efficiently and effectively maintain the links between the network and a preponderance of device of the present invention, a command and control channel (C²) may be used to carry relevant information between the devices. This C² link may be implemented on any suitable channel within the air interface standard, such as a Stand Alone Dedicated Control Channel (SDCCH), a Fast Associated Control Channel (FACCH), Cell Broadcast Channel (CBCH), a Slow Associated Control Channel (SACCH), or any equivalent control channel used in other protocols. The C² link may also utilize vacant bandwidth in the air interface in a non-standard manner to accomplish the same objective. For example, in the GSM system, if multiple channels are operating on the same frequency (that is, all are using F1, but on different time slots), then one SACCH is needed to maintain link quality between two nodes. The remaining SACCHs are effectively redundant, and therefore may be usurped for the C² link. Similarly, a non-standard physical channel may use a standard logical channel. For example, in GSM, the Cell Broadcast channel is required to reside on SDCCH:2 of the broadcast channel. A non-standard CBCH could also be implemented on a physical channel other than SDCCH:2, which only devices of the present invention would use.

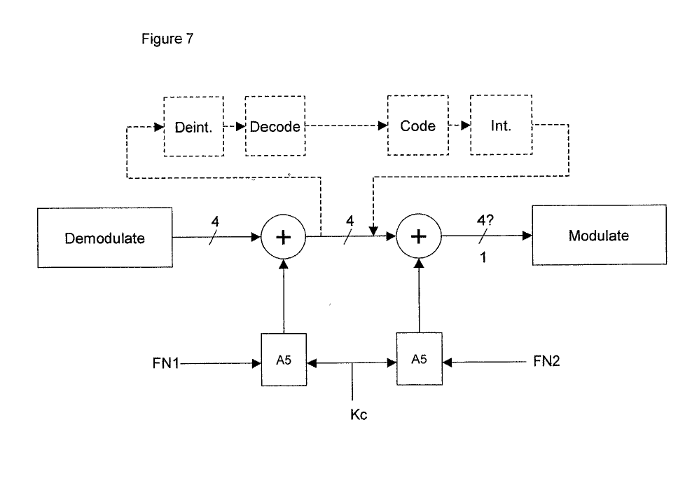

It is important to maintain the privacy of all radio links, therefore, the device provides encryption capabilities commensurate with the radio standards. Each link may be encrypted using appropriate authentication procedures and cipher variables are used to encrypt information flowing across the radio interface. This is represented in FIG. 7. The network will pass cipher variables, such as RAND and SRES in the GSM network, over the appropriate links between a MS and BTS. It is undesirable for a device of the present invention to contain user cipher keys (e.g., Ki), however, session keys (e.g., Kc) that are unique to each link may be used within the device. The best way to transfer Kc to a device of the present invention is over a pre-established, heavily encrypted link wherein triplets used within the security procedures (e.g., RAND, SRES, Kc) are available to each device for subsequent authentication of MSs. An apparatus of the present invention must continually monitor signaling information from a BTS in order to determine if a directed change is being commanded which could corrupt the channel. Directed changes of this sort include such things as a channel change command, cipher mode change, data rate change, handover, etc. The device will intercept all signaling messages and then demodulate, decipher, deinterleave and decode these messages to determine if a directed change message is included. If not, the message may be passed on through the network. If one is intercepted, each device of the present invention must determine what course of action to take to maintain connectivity.

Improved Frequency Management of the Present Invention

Where traditional cellular networks rely upon external information to develop frequency plans and power level schemes, the device uses the built-in mobile station (nMS) functionality to detect, quantify and report on the best available frequency channels within its vicinity. By using the nMS function, frequency selections are immediate. This differs from the traditional network where a significant network planning effort is undertaken to determine radio wave propagation characteristics after which a frequency map is applied to the network. This network plan will typically be validated using a “drive-test” to measure power levels from a multitude of base stations by driving throughout the coverage area with measurement equipment, collecting the data, then reducing the data to usable form through post processing. The frequency set may then be programmed into the network base stations. The process will likely take several weeks or several months.

Another method to determine frequency plans is to use statistical analysis of measurement data received from Mobile Stations within the network. Traditionally, an MS will report on the frequency, power level and signal quality of surrounding base stations that it can receive. When the MS is communicating with the network, it reports these measurements as part of its link management processing in preparation for handover to another base station. By collecting and post-processing this information, a network-based algorithm may determine optimum frequency and power levels. The resulting frequency plan may then be programmed into the network base stations, again taking several days or weeks to collect a statistically significant sample. A drawback to this technique is the uncertainty with respect to the relative location of the measurement device (ie, MS) to the measured base stations. The device of the present invention has the ability to collect the same information directly and immediately, without impacting communications channels (it merely measures power and frequency from surrounding base stations). Because the precise location of the devices of the present invention are known relative to base stations (and each other), coverage areas and shadowing may be more accurately quantified.

Because the effect of dynamic frequency allocation is immediately seen within the network frequency reuse is significantly improved. It can be demonstrated through simple analysis that the capacity within a cellular network is limited by co-channel interference, that is, surrounding base stations transmitting on the same frequencies will cause interference in a receiver, thus limiting the quality of service, and the effective capacity of the network. The device is unique in that each of these devices has the ability to monitor frequency utilization within its field of view. Of primary interest is base station frequency utilization, but mobile station utilization is also important. Autonomous frequency management utilizes all available information obtained from the network including direct power spectrum measurements, decoding of system information messages of BTSs to obtain cell allocation and mobile allocation sets, configuration information passed over a C² network, and network derived information that is obtained through C² feedback paths. An Operations and Maintenance Center (nOMC) may act as the collector and arbitrator of frequency plans within and among devices of the present invention in the network.

Network Management in the Present Invention

To make efficient utilization of a device of the present invention within a larger overarching cell, it is useful for the device to bias a MS to itself, rather than to a base station. Within the GSM protocol, broadcast parameters are used for this purpose. Other protocols use similar techniques. The device, for example, would set the appropriate Temporary Offset values and timers so that the device would look exceedingly desirable to a MS that may be able to monitor a BTS and the device of the present invention simultaneously. Once a timer expires in the MS (implying that the MS has loitered near the device longer than a quickly passing vehicle), the MS adds an offset value to the device's channel measurement making the device more desirable by the amount of the offset. This would cause the MS to continue to “camp-on” the device, even if a BTS signal is stronger. The net result is that the continuous reselection between device and BTS is averted.

Latency

By designing the device to utilize decoupled links, latency is introduced into a channel. Because of the way that radio links are engineered, latency can be accommodated within a data network. However, human cognition of voice may be impacted if a large latency is introduced into a network. It is critical to implement a network wherein latency is minimized. The device minimizes latency by translating communications channels as quickly and efficiently as feasible while maintaining good link performance. FIG. 7 is a block diagram of a representative channel process. Non-signaling channels are demodulated, and the samples are sent directly to a modulator for conversion to an alternate frequency. When a signaling channel is detected, it will be deciphered, deinterleaved and decoded on the receive side. Processing is performed on this message, and if necessary, the same message, or a modified version of the message will be coded, interleaved, encrypted and modulated on the alternate frequency in a subsequent time slot.

We claim:

1. A wireless communication apparatus for communicating with one or more base stations and one or more mobile stations comprising
a base station portion and a mobile station portion, said base station portion being adapted to communicate with one or more mobile stations and/or with one or more other mobile station portions; and
a mobile station portion adapted to communicate with one or more other base stations and or one or more other base station portions.

2. The apparatus according to claim 1 wherein control of mobile station functionality and base station functionality is provided by at least one control processor.

3. The apparatus according to claim 1 wherein said mobile station portion comprises at least one downlink receiver and at least one uplink transmitter

4. The apparatus according to claim 1 wherein said mobile station portion further comprises at least one baseband processor.

5. The apparatus according to claim 1 wherein said base station portion comprises at least one downlink transmitter and an uplink receiver.

6. The apparatus according to claim 1 wherein said base station portion further comprises at least one baseband processor.

7. The apparatus according to claim 1 wherein there is an interface between said base station and said mobile station portion and an interface between a mobile station to said base station portion and said interfaces are decoupled.

8. The apparatus according to claim 7 wherein the mobile station portion and the base station portion have multiple physical channels.

9. The apparatus according to claim 8 wherein there are more receive channels present than transmit channels.

10. The apparatus according to claim 1 wherein a virtual mobile station is created when there is communication with a base station or base station portion.

11. The apparatus according to claim 1 wherein a virtual base station is created when there is communication with a mobile station or a mobile station portion.

12. The apparatus according to claim 1 wherein a proxy mobile station is created with a protocol entity that behaves as a mobile station.

13. The apparatus according to claim 1 wherein a proxy base station is created with a protocol entity that behaves as a base station.

14. The apparatus according to claim 1 wherein there are multiple instances of mobile stations and base stations that are used to provide connectivity among all relevant nodes in a network.

15. The apparatus according to claim 1 further comprising a command and control channel that is used to carry relevant information between other communication devices.

16. The apparatus according to claim 1 wherein the mobile station portion detects, quantifies and reports on the best available frequency channels within its vicinity.

17. The apparatus according to claim 16 wherein said detection, quantification and reporting by the mobile station portion is immediate.

18. The apparatus according to claim 16 wherein information is collected directly by measuring power and frequency from surrounding base stations, without utilizing communications channels.

19. The apparatus according to claim 1 wherein there is communication between the mobile station portion and the base station portion.

20. A system comprising one or more wireless communication devices for communicating with one or more base stations and one or more mobile stations said device comprising
a base station portion and a mobile station portion, said base station portion being adapted to communicate with one or more mobile stations and/or with one or more other mobile station portions; and
a mobile station portion adapted to communicate with one or more other base stations and or one or more other base station portions.

21. The system according to claim 20 wherein control of mobile station functionality and base station functionality in one or more of said devices is provided by a control processor.

22. The system according to claim 20 wherein one or more devices have a mobile station portion comprising a downlink receiver and an uplink transmitter

23. The system according to claim 20 wherein said mobile station portion further comprises a baseband processor.

24. The system according to claim 20 wherein one or more of said devices have a base station portion comprising a downlink transmitter and an uplink receiver.

25. The system according to claim 20 wherein said base station portion further comprises a baseband processor.

26. The system according to claim 20 wherein there are multiple instances of mobile stations and base stations that are used to provide connectivity among all relevant nodes in a network.

27. A system according to claim 20 further comprising an operations and maintenance center that acts as a collector and arbitrator of frequency plans.

28. The system according to claim 20 wherein each device has an ability to monitor frequency utilization within its field of view.

29. A network comprising one or more wireless communication devices for communicating with one or more base stations and one or more mobile stations said device comprising
a base station portion and a mobile station portion, said base station portion being adapted to communicate with one or more mobile stations and/or with one or more other mobile station portions; and
a mobile station portion adapted to communicate with one or more other base stations and or one or more other base station portions.

30. An apparatus according to claim 1 wherein said base station portion dynamically determines efficient routing paths based on prioritization, network loading and node availability.

31. An apparatus according to claim 1 wherein said mobile station portion allocates channels based on a survey conducted to detect and identify the best available downlink channel.

32. An apparatus according to claim 1 wherein latency of direct transfers is minimized by connecting an uplink receive path with an uplink transmit path and a downlink receive path with a downlink transmit path.

33. An apparatus according to claim 31 wherein channel selection is based on reported results from one or more base stations.

34. A method of wireless communication among one or more base stations and one or more mobile stations comprising:
communicating with an apparatus comprising a base station portion and a mobile station portion, said base station portion being adapted to communicate with one or more mobile stations and/or with one or more other mobile station portions; and
a mobile station portion adapted to communicate with one or more other base stations and or one or more other base station portions.

35. The apparatus according to claim 1 wherein said mobile station portion comprises at least one downlink transmitter and at least one downlink receiver

36. The apparatus according to claim 1 wherein said mobile station portion comprises at least one uplink transmitter and at least one uplink receiver.

37. The apparatus according to claim 1 wherein said base station portion comprises at least one downlink transmitter and at least one downlink receiver.

38. The apparatus according to claim 1 wherein said base station portion comprises at least one uplink transmitter and at least one uplink receiver.

39. The apparatus according to claim 1 being adapted to communicate with another apparatus of the same type.

40. The system according to claim 1 wherein one or more wireless communication devices for communicating with one or more base stations and one or more mobile stations said device are controlled by a single control processor.

41. The apparatus according to claim 1 being used to monitor existing base station activity.

42. The apparatus according to claim 1 wherein the base station portion of the apparatus can control activity of mobile stations.

43. The apparatus according to claim 1 wherein the frequency of the base station portion and the frequency of the mobile station portion are decoupled.

44. The apparatus according to claim 1 wherein the modulation of the base station portion and the modulation of the mobile station portion are decoupled.

45. The apparatus according to claim 1 wherein the amplitude of the base station portion and the amplitude of the mobile station portion are decoupled.

46. The apparatus according to claim 1 wherein the data rate of the base station portion and the data rate of the mobile station portion are decoupled.

47. The apparatus according to claim 1 wherein the protocol of the base station portion and the protocol of the mobile station portion are decoupled.

48. The apparatus according to claim 1 wherein the action between the base station portion and the mobile station portion may be decoupled.

49. A method of communication among one or more base stations and one or more mobile stations comprising:
communicating with an apparatus comprising a base station portion and a mobile station portion, said base station portion being adapted to communicate with one or more mobile stations and/or with one or more other mobile station portions; and
a mobile station portion adapted to communicate with one or more other base stations and or one or more other base station portions.
